(19) United States
(12) Patent Application Publication
(10) Pub. No.: US 2014/0081735 A1
(43) Pub. Date: Mar. 20, 2014

(54) STAMP ISSUING METHOD AND STAMP ISSUING SYSTEM

(71) Applicant: DIGITAL METEORITE LIMITED, Hong Kong (CN)

(72) Inventors: Wing-Fung YU, Hong Kong (CN); Jason Felix Tsz-Kiu Chiu, Hong Kong (CN)

(73) Assignee: DIGITAL METEORITE LIMITED, Hong Kong (CN)

(21) Appl. No.: 14/030,703

(22) Filed: Sep. 18, 2013

(30) Foreign Application Priority Data
Sep. 18, 2012 (CN) CN201210347800.1

(51) Int. Cl. G06Q 30/02

(52) U.S. Cl. CPC G06Q 30/0226
USPC 705/14.27

(57) ABSTRACT

A stamp issuing method and a stamp issuing system are provided. In an embodiment, the method includes the following steps. Stamp information is generated by a stamp issuing terminal based on (1) consumption information transmitted from a retail terminal and (2) a predetermined stamp issuing rule. The stamp information is sent to a mobile terminal. The stamp information and account information of the mobile terminal is sent to a server from the stamp issuing terminal. The mobile terminal is associated with a user account. If the authentication is successful, the stamp information is stored, by the mobile terminal, in the user account associated with the mobile terminal. The stamp information is stored and updated, by the server, in a user account that corresponds to the mobile terminal. Using this method, at least one embodiment can send a stamp to the mobile terminal, via the stamp issuing terminal.

### FIELD

The present specification relates to electronic purchases.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In order to attract a customer back to a store for purchase, the store often issues a physical stamp after consumption by the customer, and the physical stamp needs no support from a computer system. However, the physical stamp is easy to lose, inconvenient to organize and unpopular with the customer. In this specification, the term “consumption” refers to purchasing, using, and/or receiving goods and/or services.

Prior customer reward systems take a membership card as identity verification. After consumption by the customer, a stamp is issued to an account of the customer, with support from a computer system. Chain-operated department stores, supermarkets, electric appliance retail stores or restaurants use a membership system or regular customer points to attract the customer back to the store for purchase, such as Ponta of Japan Lawson Convenience Store, Star Rewards of USA Macy Department Store, Money Back of Hong Kong Parknshop Supermarket, or Point Scheme of China Mobile. The purpose of operating such customer point schemes is to attract customer back to the store for purchase and increase the loyalty of the customer. However, the cost of operating such customer point schemes is relative high, especially using a server and database software to process a large amount of data, which is not affordable to small and medium-sized stores. Therefore, small and medium-sized stores can only use the easiest membership system to attract a customer, such as issuing a membership card. However, the consumer also has to make a choice among various membership cards as to which membership cards to place in a wallet, which is not a convenient way to view existing reward points.

With popularization of a smart phone, prior customer reward systems may issue a stamp via the smart phone. For example, Starbucks launched a customer reward scheme in 2009, which produces a two-dimensional barcode coupon on the display screen of the smart phone. the barcode coupon may be sent in a message to the user's smart phone. A store owner or manager stores at a sales location the same barcode and directly reads the barcode that is displayed on the display of the mobile phone of the customer by a two-dimensional barcode scanner, so that the customer may pay an order through an application 232 installed in the mobile phone. At the same time, the reward scheme provides a user interface that the customer may use to make a real-time inquiry about information of an account, via the mobile phone. The user interface may provide special advantages to the user. However, such customer reward systems operated by a large enterprise has high cost, only suitable to a single enterprise, and meanwhile, does not provide a personalized commodity promotion activity in the reward scheme.

As can be seen from the above, the prior art have inconveniencies and deficiencies in practical applications, so it is necessary to make an improvement.

### SUMMARY

In view of the above deficiencies, an embodiment of the system provides a reward method and a reward system based on a visit of a customer, in which a stamp can be sent to a mobile terminal from a stamp issuing terminal Allowing the stamp to be sent to the mobile terminal makes the stamp inquiry convenient, the user experience is enhanced, and the cost is reduced as a result of the use of the mobile terminal as a carrier for the stamp. Further, in an embodiment, a purchase receipt in an electronic format can be downloaded to the mobile terminal as a proof of purchase, and detailed data of the purchase receipt may be used by consumer to calculate expense in consumption classifications of the customer per month and by retailer to calculate special consumption reward scheme.

The reward method for rewarding a visit of a customer to the premises of a merchant comprises issuing a physical stamp or recording a point. In the present specification, issuing an electronic stamp is one form of rewarding customer for visiting the premises of a merchant.

In order to issue a stamp, a stamp issuing method is provided, which includes at least the following steps. Stamp information is generated according to consumption information transmitted from a retail terminal and a predetermined stamp issuing rule by a stamp issuing terminal. The stamp information is sent to a mobile terminal, and the stamp information and account information of the mobile terminal is sent from the stamp issuing terminal to a server. The mobile terminal is associated with a user account. The stamp information is authenticated. The stamp is stored into the user account associated with the mobile terminal after the authentication is successful by the mobile terminal. The stamp information is stored, by the server, in the user account corresponding to the mobile terminal, and the user account is updated.

At least one embodiment further provides a stamp issuing system, which includes at least a retail terminal adapted to provide consumption information to a stamp issuing terminal. The stamp issuing terminal is adapted to generate stamp information according to the consumption information and a predetermined stamp issuing rule. The stamp issuing terminal is adapted to send the stamp information to a mobile terminal and to send the stamp information and account information of the mobile terminal to a server. The mobile terminal to which the stamp information is sent is associated with the user account at the server (and optionally also at the stamp issuing terminal). The mobile terminal is adapted to authenticate the stamp information, and if the authentication is successful, to store the stamp into the user account associated with the mobile terminal. The server is adapted to store and update the stamp information in the user account (which may be stored at the server) corresponding to the mobile terminal.

In at least one embodiment, the stamp issuing terminal sends the stamp information to the mobile terminal, and sends the stamp information and the account information of the mobile terminal to the server. The mobile terminal stores the stamp into the user account associated with the mobile terminal. The server stores and updates the stamp information in the user account corresponding to the mobile terminal. In at least one embodiment, the mobile terminal acts as a carrier of the stamp, without needing to store and/or without storing a stamp or a membership card as physical entity. Further, the user can inquire about the stamp in the user account by using the mobile terminal, thereby providing a better consumption experience to the customer. By establishing a low cost customer reward platform, which can be shared by a plurality of stores, and storing various types of stamps in the same mobile terminal, the competitive power of the marketing medium and of small stores can be greatly increased. Also, in at least one embodiment a stamp can be sent to the mobile terminal from the stamp issuing terminal, the stamp inquiry becomes convenient, the user experience is enhanced, and the cost is reduced due to the use of the mobile terminal as a carrier for the stamp. For example, the user may be able to query the server to obtain the stamp information by themselves, without need to speak to a person. Also, in the at least one embodiment, consumption behavior of the customer can be analyzed and obtained according to the customer data. The customer may be provided with an advertisement that is effective, attractive, and conforms to customer preferences that are derived from customer patterns of consumption (which increasing the effectiveness of the article advertisement).

In an embodiment, the stamp issuing terminal sends the consumption information to the mobile terminal and the server. The retail terminal verifies the consumption information displayed on the mobile terminal, so that in at least one embodiment, the purchase receipt can be downloaded to the mobile terminal in an electronic format, as a proof of purchase.

Any of the above embodiments may be used alone or together with one another in any combination. Inventions encompassed within this specification may also include embodiments that are only partially mentioned or alluded to or are not mentioned or alluded to at all in this brief summary or in the abstract.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1A is a block diagram of a structure of a stamp issuing system according to the at least one embodiment;

FIG. 1B shows a block diagram of an embodiment of the system of FIG. 1A;

FIG. 1C shows a block diagram of an embodiment of the memory of mobile terminal of FIG. 1A;

FIG. 1D shows a block diagram of an embodiment of the memory of server 140 of FIG. 1A;

FIGS. 2A and 2B are flowcharts of a stamp issuing method according to at least one embodiment;

FIGS. 3A and 3B are flowcharts in which stamp information is encrypted according to a first embodiment;

FIGS. 4A and 4B are flowcharts in which the stamp information is authenticated by a mobile terminal according to a second embodiment;

FIGS. 5A and 5B are flowcharts in which a reward is provided to the mobile terminal by a server according to a third embodiment;

FIGS. 6A and 6B are flowcharts in which an advertisement is pushed according to a fourth embodiment;

FIG. 7 shows a block diagram of an embodiment of a computer system that may be used as the retail terminal and/or server of FIG. 1A;

FIG. 8 shows a block diagram of an embodiment of stamp issuing terminal used in the system of FIG. 1;

FIG. 9 shows a block diagram of an embodiment of mobile terminal used in the system of FIG. 1; and

FIG. 10 shows a block diagram of an embodiment of the electromagnetic signal generator of the stamp issuing terminal of FIG. 1A.

### DESCRIPTION OF THE PREFERRED EMBODIMENTS

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

It should be understood that specific embodiments described herein are only used to explain at least one embodiment but not used to limit the present invention.

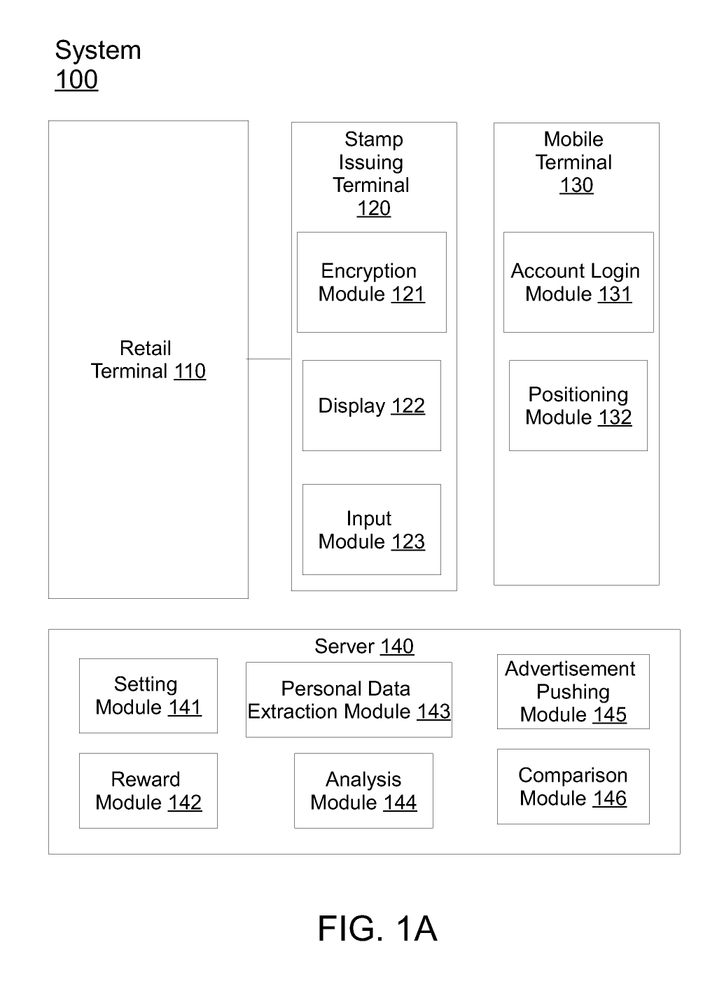

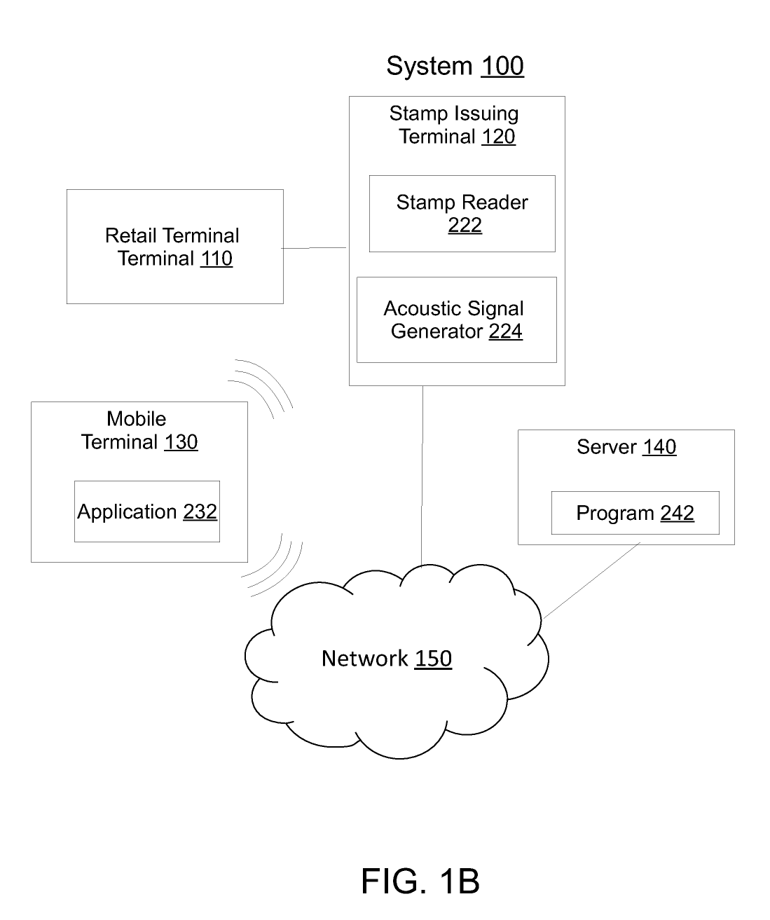

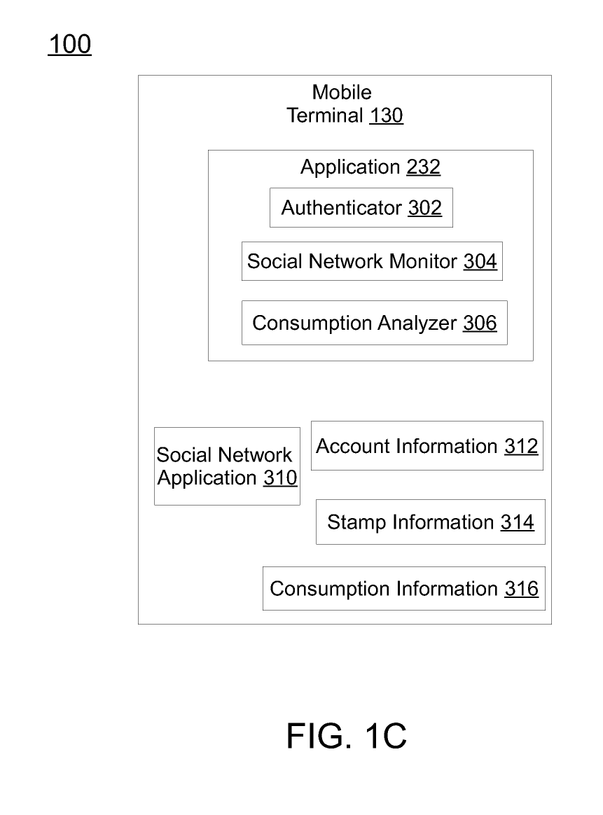

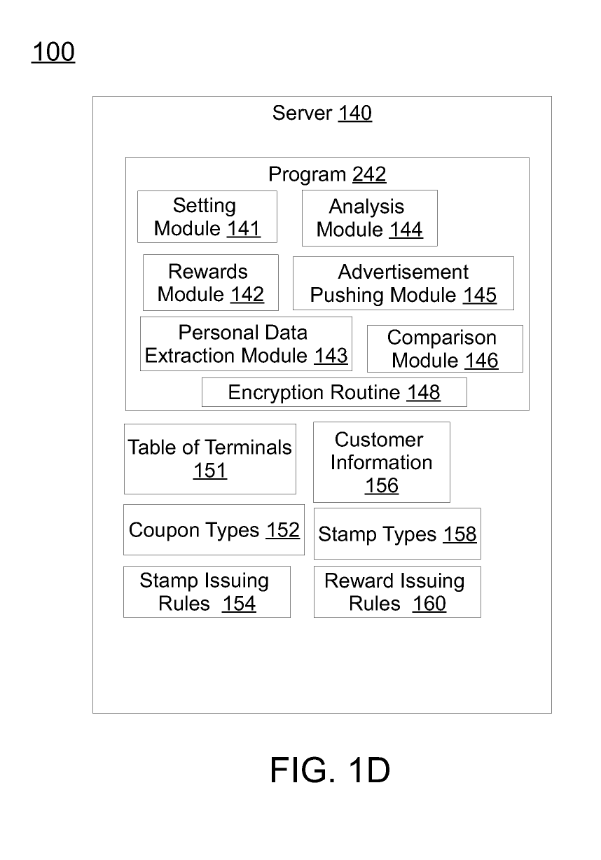

FIG. 1A illustrates a structure of a stamp issuing system 100 of at least one embodiment. Stamp issuing system 100 includes at least a retail terminal 110, a stamp issuing terminal 120, which includes encryption module 121, display 122, and input module 123. Stamp issuing system 100 also includes a mobile terminal 130 having account login module 131 and positioning module 132. Stamp issuing system 100 also includes a server 140 having setting module 141, reward module 142, personal data extraction module 143, analysis module 144, advertisement pushing module 145, and comparison module 146. In other embodiments, system 100 may not have all of the elements or features listed and/or may have other elements or features instead of, or in addition to, those listed.

Briefly, retail terminal 110 is a terminal used by a retailer for conducting a transaction. Retail terminal 10 may be a smart cash register, for example. Retail terminal 110 may track inventory and sales as transactions, such as by updating sales and inventory information as transactions are performed, for example. Stamp issuing terminal 120 issues stamps to customers. The stamps may be issued to customers as a reward for visiting the retail establishment and/or for purchasing items. Stamp issuing module 120 collects consumption information 316 from retail terminal 110 and forwards the information to a server and/or uses the information to determine whether to issue a stamp. The term consumption information and purchase information are used interchangeably, and may be substituted one for another to obtain different embodiments. Stamp issuing module 120 may also forward information about stamps issued to the server. Encryption module 121 encrypts stamps and/or consumption information 316 prior to sending the stamp information 314 to the server. Display 122 displays stamp information 314 and/or other information. Input module 123 may be used to operate stamp issuing terminal 120. Input module 123 may include a stamp reader for reading stamps presented by a customer claiming benefits to which the customer is entitled, as a result of presenting the stamp. Mobile terminal 130 is a device operated and/or owned by the customer. Mobile terminal 130 may be a smart phone. Login module 31 is a module for logging into a server and/or a social network. The user may login to server via the social network. Positioning module 132 may keep track of the customer's location. The customer's location may be used to determine whether or not the customer is authentic or fraudulent. In an embodiment, a customer not located at the retail establishment may be considered to be fraudulent. Server 140 is a server that tracks customer data and analyzes the customer data to determine customer preference. Server 140 may also track stamps issues and redeemed, and may track rewards offered to customers. Setting module 141 may be used by the retailer to input stamp issuing rules, reward issuing rules, and rules for sending advertisements. Setting module 141 may also be used for uploading advertisements to send. Mobile terminal 130, via login module 31, for example, may also access setting module 141 to enter customer preferences related to advertisements received, stamps issued, and rewards awarded. Reward module 142 determines whether to award rewards to customers. Rewards may be issued based on the number of purchases and/or the stamps associated with a customer. Personal data extraction module 143 may extract personal data from a user based on user input, user usage of a social network, and/or purchasing history. Analysis module 144 may analyze the personal data extracted by personal data extraction module and purchase information. Analysis module 144 may determine which advertisements to send a customer based on purchase information. Advertisement pushing module 145 pushes advertisement to customers based on the analysis of analysis module 144. Comparison module 146 compares user information to other information to determine whether the user is authentic or fraudulent. For example, comparison module 146 may compare the users location to the location of a stamp issuing terminal to determine whether the mobile terminal 130 is within or near a retail establishment (if the user is not near enough to the location of the stamp issuing module 120, the user is assumed to be fraudulent).

To elaborate further, the system 100 includes a program running on the server 140 and an application 232 running on the mobile terminal 130, the server 140 communicates with the mobile terminal 130 via a mobile communication network.

The retail terminal 110 is adapted to provide consumption information 316 to the stamp issuing terminal 120. Specifically, a customer purchases an article and pays at a POS (Point of Sale) retail terminal 110, the retail terminal 110 is connected to the stamp issuing terminal 120 and consumption information 316 (namely detailed data of purchase receipt) of the customer is sent to the stamp issuing terminal 120 from the retail terminal 110. Retail terminal 110 may be directly connected stamp issuing terminal 120, via a communications cable and/or communicate with stamp issuing terminal 120, via a local area network and/or wide area network. The consumption information 316 may include a serial number of the purchase receipt, date and time of the purchase receipt, code of a POS processing purchase, code of the article, a unit price of the article, an amount of the article, total value of the purchase receipt, and/or ticket information, and the like. At the same time, the retail terminal 110 verifies the consumption information 316 displayed on the mobile terminal 130, so that the traditional printed purchase receipt and paper ticket can be replaced by the mobile terminal 130. In an embodiment, the retail terminal 110 comprises a computer and a POS machine connected to the computer. The POS machine may be a smart cash register and/or other machine that performs the financial transaction. The number of stamps awarded may be proportional to the monetary value of the purchases. The stamp may be given to a customer who purchases an article, for example, one stamp may be given for USD 100 consumption, and ten stamps may be given for USD 1000 consumption. Alternatively, another formula may be used for determining the number of stamps to award. For example, the number of stamps awarded per dollar may increase with the size of the purchase and/or the total value of all purchases during a particular time period according to a polynomial function, logarithmically, and/or exponentially. Accordingly, one stamp may be awarded for an item that costs $10 and 25 stamps may be awarded for an item that costs $200. As another example, a certain number of stamps may be awarded for each purchase regardless of the amount of the purchase in addition or instead of awarded purchases based on the monetary value of the purchases.

The stamp issuing terminal 120 is adapted (e.g., configured, hardwired, and/or programmed) to generate stamp information 314 according to the consumption information 316 and a predetermined stamp issuing rule and send the same to the mobile terminal 130. In this specification wherever the adapted, configured, hardwired, and programmed may be substituted for one another to obtain broader, more specific, and/or different embodiments (adapted and configured differ slightly in scope, while hardwired and programmed are different embodiments that are more specific examples of adapted and of configured). The stamp issuing terminal 120 is further adapted to send the stamp information 314 and account information 312 of the mobile terminal 130 to the server, the mobile terminal 130 is associated with a user account. Wherein, the stamp information 314 mainly comprises a terminal code of the stamp issuing terminal, a serial number of the stamp information 314, time of the stamp information 314, article classification code, stamp code, and stamp amount, for example. The predetermined stamp issuing rule may be S=P/100, for S is the number of stamps issued, P is the value of the purchases of the consumer to whom the stamps are awarded. For example, one stamp may be obtained for USD 100 consumption (because S=P/100=100/100=1), and ten stamps may be obtained for USD 1000 consumption (because S=P/100=1000/100=10). The stamp may be displayed as two-dimensional barcode or other pattern.

The stamp issuing terminal 120 is designed to be adapted to the shape of the mobile terminal 130, when the stamp issuing terminal 120 and the mobile terminal 130 transmit a signal to each other, the mobile terminal 130 is simply placed on the stamp issuing terminal 120. The stamp issuing terminal 120 may include a camera and/or a barcode reader, which reads the stamp on the screen of mobile terminal 130. Stamp issuing terminal 120 includes software for capturing the signals from the stamp reader, which stores and then analyzes the signals and extracts information contained on the stamp. The software may also authenticate the stamp to determine whether the stamp is authentic. The stamp issuing terminal 120 is further linked with the server 140 to send a stamp statement to the server 140, at one or more specific times, the stamp statement includes a code of a specific device, next stamp signal code, stamp amount, and stamp signal amount, for example. The specific time is real-time, that is, a stamp statement is immediately sent to the server 140 as soon as a stamp needs to be issued due to sale. The one or more specific times at which the statements are sent may include a periodic set of times at which statements are sent. For example, statements may be sent every four hours, every day, every month, every year, and/or another time period.

In an embodiment, the stamp issuing terminal 120 is further adapted to send the consumption information 316 to the mobile terminal 130 and the server 140. That is, the purchase receipt, in an electronic format, is downloaded to the mobile terminal 130, as a proof of purchase, which can be stored for a long time. The purchase receipt may be a ticket, which is stored in the mobile terminal, so that in the present specification, the traditional printed purchase receipt can be replaced by the ticket stored in mobile terminal, which acts as the proof of purchase when the customer leaves a purchase location. The ticket may also be used to prove the article's purchase date when a customer wants to return, exchange, or maintain the article. At the same time, if the purchased article is a ticket, for example a ticket for cinema or amusement park, the stamp issuing terminal 120 may format the purchase receipt as an electronic ticket, including one-dimensional or two-dimensional barcode electronic ticket. When a customer enters, the ticket is displayed, via the mobile terminal 130, the ticket is read by a scanner of the retail terminal 110. Furthermore, the stamp issuing terminal 120 is further adapted to send only the serial number of the purchase receipt to the mobile terminal 130 and the consumption information 316 to the server 140. The mobile terminal 130 may download all the consumption information 316 from the server 140 according to the serial number of the purchase receipt. Therefore, the server 140 sends all the consumption information 316 to the mobile terminal 130. Thus, the amount of information that the stamp issuing terminal 120 sends to mobile terminal 130 is reduced, and the time the customer spends to purchase article is hence reduced compared to were information sent from the stamp issuing terminal 120 directly to send the consumption information 316 to the mobile device 130.

In an embodiment, the stamp issuing terminal 120 may include an acoustic signal generator 224, which may be an electro-magnetic converting apparatus or a near field communication (NFC) transceiver. The acoustic signal generator 224 is adapted to convert the stamp information 314 into an audio signal and send the audio signal to a microphone of the mobile terminal 130. The electromagnetic signal generator 124 is adapted to convert the stamp information 314 into an electromagnetic signal and send the same to an electromagnetic signal sensor of the mobile terminal 130. The near field communication transceiver is adapted to convert the stamp information 314 into a radio wave signal and send the same to a smart card chip of the mobile terminal 130.

The acoustic signal generator 224 may include a mini speaker, and the acoustic signal generator 224 may include a protective shell, which may attenuate sound, for preventing the adjacent mobile terminals from receiving the audio signal sent out from the acoustic signal generator 224. The intensity of the audio signal sent out by the mini speaker is adjusted to such a level that a microphone of a general mobile terminal cannot receive the audio signal until the microphone is close to being adjacent to the microphone (e.g., within a few millimeters or within a millimeter). By generating an audio signal that require the mobile terminal 130 to be next to acoustic signal generator 224, facilitates sending the stamp confidentially near field.

Stamp issuing terminal 120 includes an electromagnetic signal generator 124 in which electrodes and the intensity of the electromagnetic are controlled by an electric current direction and electromagnetic flux. The electromagnetic flux generates a magnetic pole. The magnetic pole direction of the electromagnetic intensity of the magnetic field is varied, and the magnetic pole acts as a signal carrier. In an embodiment, a signal is transmitted as a magnetic pole direction, for example, a signal is transmitted when the direction of the magnetic pole changes at a specific time. For example, a “100101” signal is transmitted according to a rule of one bit per 0.01 second, the signal is as shown in Table 1:

TABLE 1

| | time point | | | | | |
|---|---|---|---|---|---|---|
| | 0.00 | 0.01 | 0.02 | 0.03 | 0.04 | 0.05 |
| Bit | 1 | 0 | 0 | 1 | 0 | 1 |
| magnetic pole direction | N-S | S-N | S-N | N-S | S-N | N-S |

However, N-S is a North-South pole arrangement. S-N is a South-North pole arrangement. The mobile terminal 130 senses the intensity and change of the magnetic field, where the mobile terminal 130 is located by using a built-in electromagnetic signal sensor (e.g., an antenna), so as to realize signal transmission.

The near field communication transceiver is to send the stamp information 314 to the mobile terminal 130 by converting the stamp information 314 into a radio wave signal. The mobile terminal 130 may include a smart card chip capable of storing the stamp application 232, such as a SIM card or a Secure Memory Card. The chip can also be an additional built-in smart card. The near field communication transceiver performs wireless communication with the chip of the smart card in the mobile terminal 130 to realize stamp information 314 transmission.

In an embodiment, the stamp issuing terminal 120 further includes an encryption module 121, which is adapted to encrypt the stamp information 314 with a private-key or a public-key distributed by the server 140.

In an embodiment, the stamp issuing terminal 120 further comprises a display 122 and an input module 123, the input module 123 is used to operate the stamp issuing terminal 120 by a user, for example, to input, modify or delete data. The display 122 is used to display the stamp information 314, user information and the like.

The mobile terminal 130 is adapted to authenticate the stamp information 314, and store the stamp into the user account associated with the mobile terminal 130 after authentication is successful. Specifically, the mobile terminal 130 communicates with the stamp issuing terminal 120, receives the stamp information 314 transmitted by the stamp issuing terminal 120, and authenticates and decrypts the stamp information 314. The mobile terminal 130 generally performs the authentication and decryption in the following three manners (1) to perform the authentication and decryption with a predetermined PKI (Public Key Infrastructure), (2) to send the stamp information 314 to the server 140 for the authentication and decryption, and (3) the mobile terminal 130 perform the authentication and decryption by itself. When the stamp passes through authentication, the stamp is displayed on the mobile terminal 130 and stored in the mobile terminal 130, and the amount of stamp in the associated account is updated. Generally, the application 232 in the mobile terminal 130 has the following functions:

1. The application 232 may count stamps stored in the associated account, and displaying rewards which may be redeemed by the existing stamps, for selection by the customer.

2. The application 232 is associated with the reward system server 140, if a rewarded stamp, sent out by the server 140, arrives, and stamp that was awarded is displayed on the mobile terminal 130.

3. The application 232 is associated with the reward system server 140, if a lottery draw opportunity sent by the server 140 arrives, the lottery draw opportunity is displayed on the mobile terminal 130 and (if the user opts to have the lottery draw performed) the lottery draw is performed.

4. The application 232 provides an interface for a customer to select a reward coupon. The reward coupon may be a cash coupon, a coupon for an article, a service coupon, or other reward coupon. After the customer selects the reward coupon. The amount of the stamp and the effective reward coupon associated with the account are updated on the server 140.

5. The application 232 may display the reward coupon. If there is a suitable device in a store that is adapted to handle stamp redemption process, the reward coupon displayed on the mobile terminal 130 can be directly redeemed and may be deleted from the server 140.

In an embodiment, the mobile terminal 130 further includes an account login module 131, which is used to select the IMEI (International Mobile Equipment Identity) of the mobile terminal 130 or a social network account registered by the mobile terminal 130 as a user account login server 140. The login module 131, monitors the users activities and provides the server with life cycle analysis. For example, if the customer is registered in facebook, the login module 131 may extract and analyze a variety of types of information. The information extracted may include the customer's age, education, current employer, places visited, etc. The information extracted may be used to infer preferences and habits related to spending. When a customer does not provide personal information and does not select login system signal, the system automatically select the IMEI of the mobile terminal 130 as the user account. All the stamps are stored in the user account associated with the mobile terminal 130. The customer may register with and select a social network to connect to upon login and/or when turning on the mobile terminal 130. When the customer registers and selects a social network, the system of at least one embodiment may extract personal information, such as living habits, social circles and the like, from interactions that the customer has with the selected social network. Monitoring the customer's social network activities is helpful for the server 140 to analyze consumption modes of the customer. The social network includes but does not limit to Facebook, Twitter, RenRen.com, for example.

The server 140 stores and updates the stamp information 314 in the user account corresponding to the mobile terminal 130. Specifically, the server 140 receives the stamp information 314, and the corresponding user account transmitted by the stamp issuing terminal 120. Server 140 stores the stamp information 314 and updates stamp information 314, such as the stamp amount and types of stamps, for example, in the user account. The server 140 also includes a data interface, which is used for a system administrator to a establish stamp issuing terminal database, a stamp type database, a reward coupon type database, issuing stamp rule database, and stamp redeem reward coupon rule database. The stamp issuing terminal database includes coordinate data of longitude, latitude, and altitude of the stamp issuing terminal 120.

In an embodiment, the server 140 is further adapted to regularly send the consumption information 316 within a predetermined time to the retail terminal 110 and the mobile terminal 130. The retail terminal 110 is further adapted to provide, within the predetermined time, a reward based on the consumption information 316 from the mobile terminal 130 and the predetermined reward rule. Retail terminal 110 sends the reward information and the user account information 312 corresponding to the reward information to the server 140. The mobile terminal 130 performs statistics and classification on the consumption information 316 within the predetermined time. Specifically, the predetermined time may be a time that repeats are fixed intervals of time, such as one week, one month, and/or one year. The mobile terminal 130 performs statistics on the user consumption mode within each time period (including classifying the consumption data) based on the downloaded consumption information 316, for example. Mobile terminal 130 may perform statistics on specific purchase amounts and purchase item counts for food, clothes, and electric appliances, for example, in each month. The retail terminal 110 provides a special promotion activity based on detailed data of the consumption information 316 (within the predetermined time) transmitted by the server 140. For example, a hamburger store may reward two hundred stamps to a mobile terminal that purchases more than fifty hamburgers within one month. As another example, a beauty store rewards five hundred stamps to a mobile terminal that has a consumption amount of more than two thousand dollars. As a result of the consumption analysis, the user experience is enhanced and the system is more personalized to the individual users.

In an embodiment, the server 140 further comprises a setting module 141 which is adapted to associate a terminal code specific to the stamp issuing terminal 120 and a private-key or a public-key of PKI. The stamp issuing terminal 120 encrypts the stamp information 314 with the private-key distributed by the server 140.

In an embodiment, the server 140 further comprises a reward module 142 which is adapted to provide at least one optional reward to the mobile terminal 130, and update the stamp information 314 according to the reward selected by the mobile terminal 130.

The reward module 142 sends stamp reward information, lottery draw information, and reward coupon information to the mobile terminal 130 based on the stamp information 314 in the user account. Specifically, the server 140 stores a record of the stamps obtained by the customer. If a certain specific amount of stamps is obtained within a specific time, the reward module 142 issues additional stamp(s). For example, if more than two hundred stamps are obtained every day, the reward module 142 of the server 140 would reward another fifty stamps to that customer. In an embodiment, if a certain specific amount of stamps is obtained within a specific time, the reward module 142 provides a lottery draw game for the customer to play. The reward module 142 may provide one lottery draw opportunity. The lottery draw may be performed on the mobile terminal 130 in real-time, or may be performed at the end of lottery. For example, if more than five hundred stamps are obtained every day, the reward module 142 may reward one lottery draw opportunity. Alternatively or additionally, the reward module 142 sends a reward coupon redeemable from currently available stamp(s) to the mobile terminal 130 according to number of the stamps in the user account. The server 140 may further deduct the stamps that are required to redeem the reward coupon from the user account according to reward coupon information selected by the mobile terminal 130. The reward coupon may contain a one-dimensional or two-dimensional barcode. The mobile terminal 130 displays the used reward coupon. The coupon on the display of mobile device 130 may be scanned by the scanner of the retail terminal 110. When the mobile terminal 130 has used a reward coupon, the server 140 further updates the number of reward coupons.

In an embodiment, the server 140 further comprises a personal data extraction module 143, an analysis module 144 and an advertisement pushing module 145. The personal data extraction module 143 is adapted to extract personal data from the social network account registered by the mobile terminal 130. The analysis module 144 is adapted to provide a consumption analysis statement based on the personal data, the corresponding stamp information 314, and the consumption information 316 in the user account. The advertisement pushing module 145 is adapted to push an advertisement to the customer according to the consumption analysis statement. When the customer chooses to login, via the social network account, the server 140 extracts personal data of social network, and provides an analysis statement based on the stamp data, data on the purchase receipts, the analysis consumption mode, and the favorite items that the customer likes to consume, for example. The consumption analysis may include an analysis of the past consumption habit, including the percentage and dollar value of spending in specific types of goods over a specified time period, such as the past 12-months. The information extracted from the social network and other network activities, etc, forms the consumption model, which gives a projection on what is most acceptable advertisement for the customer. Based on the analysis statement, the server 140 regularly provides relevant promotional information to the customer, including a favorable stamp, for example, with respect to the consumption mode and the favorite items that the customer likes to purchase. Using the analysis module 144, at least one embodiment can analyze and obtain consumption orientation features of the customer based on the customer data. Then, advertisement pushing module 145, based on the analysis of analysis module 144, provides the customer with an advertisement article that is effective, attractive, and conforms to the customer preferences based on the consumption orientation feature, so as to increase effect of the article advertisement.

An advantage of at least some embodiments of the system 100 is that a carrier may use the mobile terminal 130 for a stamp, without storing the stamp or a membership card as a physical entity in a wallet of the customer. Furthermore, at least some embodiments system 100 allows the user to inquire about information about the remaining stamps in real-time.

Another advantage of at least some embodiments of the system 100 is to provide a method for improving the issuing of the stamp, in which the stamp is sent confidentially to the mobile terminal 130 from the stamp issuing terminal 120, by a way of near field communication. Furthermore, at least some embodiments of system 100 process different stamps issued from a plurality of stores. In other words, different retail stores may share one platform. Also, a plurality of reward schemes may be accessed by the same mobile apparatus, which acts as a stamp storage unit, as a convenience to customers that reduces the costs to the retailer to develop and maintain the system.

In an embodiment of system 100, the stamp issuing terminal 120 sends the stamp information 314 to the mobile terminal 130, and sends the stamp information 314 and the account information 312 of the mobile terminal 130 to the server 140. The mobile terminal 130 stores the stamp into the user account associated with the mobile terminal 130. The server 140 stores and updates the stamp information 314 in the user account corresponding to the mobile terminal 130. The mobile terminal 130 is used as a carrier for the stamp, without storing the stamp or the membership card as a physical entity. Moreover, the user can inquire about the stamps in the user account by using the mobile terminal 130, thereby providing a better consumption experience to the customer. By establishing a low cost customer reward platform that can be shared by a plurality of stores and by storing various stamp types on the same mobile terminal, at least one embodiment can greatly increase competitiveness of the medium and small stores. At least some embodiments of system 100 can analyze and obtain consumption orientation features of the customer based on the customer data, and provide the customer with an advertisement that is effective and attractive and conforms to the customer preferences according to the consumption orientation feature, so as to increase effect of the advertisement.

In an embodiment of system 100, the mobile terminal 130 authenticates the stamp information 314 by interacting with the server 140. The mobile terminal 130 may include a positioning module that is adapted to read present geographical position coordinates, and send the geographical position coordinates to the server 140 (in an embodiment, the geographical position coordinates include longitude, latitude, and altitude). The positioning function of the mobile terminal 130 may utilize built-in satellite positioning techniques or appropriate indoor positioning programs and methods. The server 140 further includes a position comparison module 146, which is adapted to compare the present geographical position coordinate of the mobile terminal 130 and geographical position coordinates of the stamp issuing terminal 120 sending the stamp information 314 to the mobile terminal 130. The authentication is considered successful when a distance between the present geographical position coordinates of the mobile terminal 130 and the geographical position coordinate of the stamp issuing terminal 120 sending the stamp information 314 to the mobile terminal 130 is less than a predetermined distance (for example, one kilometer). Otherwise, if the distance between the location of the mobile terminal 130 and the issuing terminal 120 is greater than the predetermined distance, the authentication is considered to have failed. If the authentication fails, the server 140 further adds an identifying number to the stamp record that is further checked by the system operator. Specifically, the mobile terminal 130 sends the stamp information 314 and the position information to the server 140. While authenticating the stamp information 314, the server 140 inquires the geographical position coordinates of the corresponding stamp issuing terminal 120 from the stamp issuing terminal database based on the terminal code of the stamp issuing terminal 120 in the stamp information 314. Then the position comparison module 146 compares the geographical position coordinates of the mobile terminal 130 with the geographical position coordinates of the stamp issuing terminal 120. The server 140 returns the authentication information to the mobile terminal 130. If the authentication is successful, the mobile terminal 130 displays and stores the stamp. The server 140 may further add an identifying number to the stamp, which is required to be authenticated, so as to prevent the same stamp information 314 from being sent to a plurality of mobile terminals 130 at different positions.

FIG. 1B illustrates a structure of a stamp issuing system 100 of at least one embodiment. Stamp issuing system 100 includes at least a retail terminal 110, a stamp issuing terminal 120, mobile terminal 130, server 140, network 150, stamp reader 222, acoustic signal generator 224, stamp issuing algorithm, server communication algorithm, application 232, and program 242. In other embodiments, system 100 may not have all of the elements or features listed and/or may have other elements or features instead of or in addition to those listed.

FIG. 1B shows an embodiment of the system 100 of FIG. 1A, which clarifies various aspects of system 100. Retail terminal 110, a stamp issuing terminal 120, mobile terminal 130, and server 140 were discussed in conjunction with FIG. 1A. As indicated in FIG. 1B, mobile terminal 130 may communicate wirelessly with stamp issuing terminal 120. Network 150 may be any combination of local area networks, wide area networks (e.g., the Internet), wireless phone networks and/or ordinary phone networks. Stamp issuing terminal 120 communicates with server 140, via network 150. Similarly, mobile terminal 130 communicates wirelessly with server 140, via network 150. Stamp reader 222 reads stamps on the display of mobile device 130. Stamp reader 222 may include a barcode reader and/or optical scanner. Stamp reader 222 may be part of input module 123 (FIG. 1A). Acoustic signal generator 224 generates an acoustic signal, conveying stamp and/or reward information to mobile phone 130. Stamp issuing algorithm issues stamps and/or may issue other rewards to mobile phone 130. Server communication algorithm automatically sends communications to and receives communications from server 140. For example, server communication algorithm may automatically send consumption information 316 to server 140 and request server 140 to authenticate the user. Server communication algorithm may also receive an authorization or command from server 140 to issue stamps or rewards to mobile terminal 130. The communication may indicate how many stamps to issue or the stamp issuing algorithm may determine on its own how many stamps to issue to mobile terminal 130. Application 232 is optional and may be an application for communicating with server 140. Program 242 is the software that runs of server 140 for tracking and issuing stamps to users. Program 242 may also determine rewards, analyze customer purchases and preferences. Program 242 may also determine whether to send ads or rewards to users and what types of ads or rewards to send to users.

FIG. 1C shows a block diagram of an embodiment of the memory of mobile terminal 130. Mobile terminal 130 may include application 232, which may include authenticator 302, social network monitor 304, and consumption analyzer 306. Mobile terminal 130 may also include social network application 310, account information 312, stamp information 314, and consumption information 316. In other embodiments, mobile terminal 130 may not have all of the elements or features listed and/or may have other elements or features instead of or in addition to those listed.

Application 232 was discussed in conjunction with FIG. 1B. Authenticator 302 may be an application that authenticates communications from server 140 and/or stamp issuing terminal 120. Social network monitor 304 may monitor communications of the user on the social network, which may determine consumption information 316 resulting by the user purchasing products via the social network. Social network monitor 304 may also determine user preferences from other information extracted from the user's interactions on the social network. Consumption analyzer 306 is optional and may analyze purchasing patterns of the user, based on consumption data 316 generated by the user's purchases, prior to sending consumption data 316 to the server 140. Social network application 310 is optional, and may be an application for interfacing with a social network. Account information 312 may include information about amounts and dates of purchases and the number of stamps and rewards awarded to the user. Stamp information 314 may include information for producing stamps on the display of mobile terminal 130. For example, stamp information 314 may include an identifier (e.g. a serial number) of the stamp, a date and time that the stamp was issued, the amount of the purchase, and the items purchased that triggered the issuance of the stamp. Consumption information 316 is optional, and may be information about the user's purchases, which may be extracted from stamp information 314, recorded as a result of purchases made via retail terminal 110 and/or social network application 310.

FIG. 1D shows a block diagram of an embodiment of the memory of server 140. Server 140 may include setting module 141, reward module 142, personal data extraction module 143, analysis module 144, advertisement pushing module 145, comparison module 146, encryption routine 148, table of terminals 151, coupon type 152, stamp issuing rules 154, customer information 156, stamp type 158, and reward rule 160. In other embodiments, server 140 may not have all of the elements or features listed and/or may have other elements or features instead of or in addition to those listed.

Setting module 141, reward module 142, personal data extraction module 143, analysis module 144, advertisement pushing module 145, and comparison module 146 were discussed in conjunction with FIG. 1A. Encryption routine 148 encrypts and decrypts messages sent between stamp issuing terminal 120 and server 140 and/or between mobile terminal 130 and server 140. Table of terminals 151 may include a list of identifiers of terminals, the locations of the terminals, retail establishments associated with each terminal and/or customers associated with each terminal. The information in the table of terminals may be used for authenticated communications from mobile terminals and/or retail terminals. Coupon type 152 may list different types of coupons that are associated with different retailers that used server 140. Stamp issuing rules 154 may include rules for issuing stamps, which may differ for different retailers. Customer information 156 may store information about various customers, such as account information, consumption information, retailers associated with the customer, and customer preferences. Stamp type 158 may store templates for different types of stamps and may associate different stamp types with different retailers. Reward rule 160 may store different rules for issuing different rewards. Different reward rules and/or different sets of reward rules may be associated with and correlated with different retailers, so that server 140 can compute whether to issue rewards to a particular customer of a particular retailer.

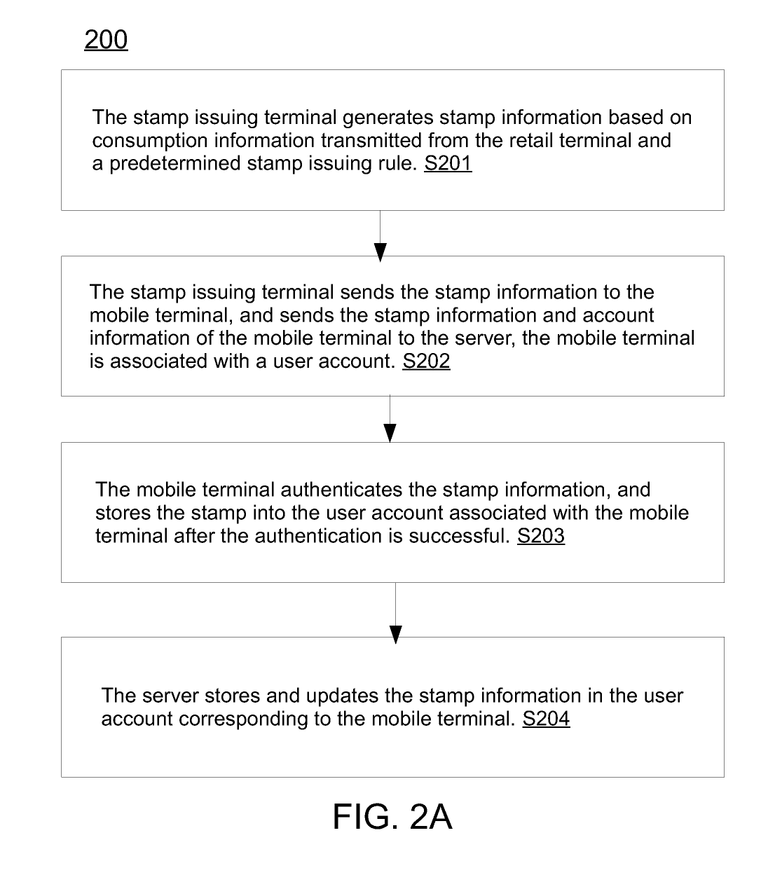

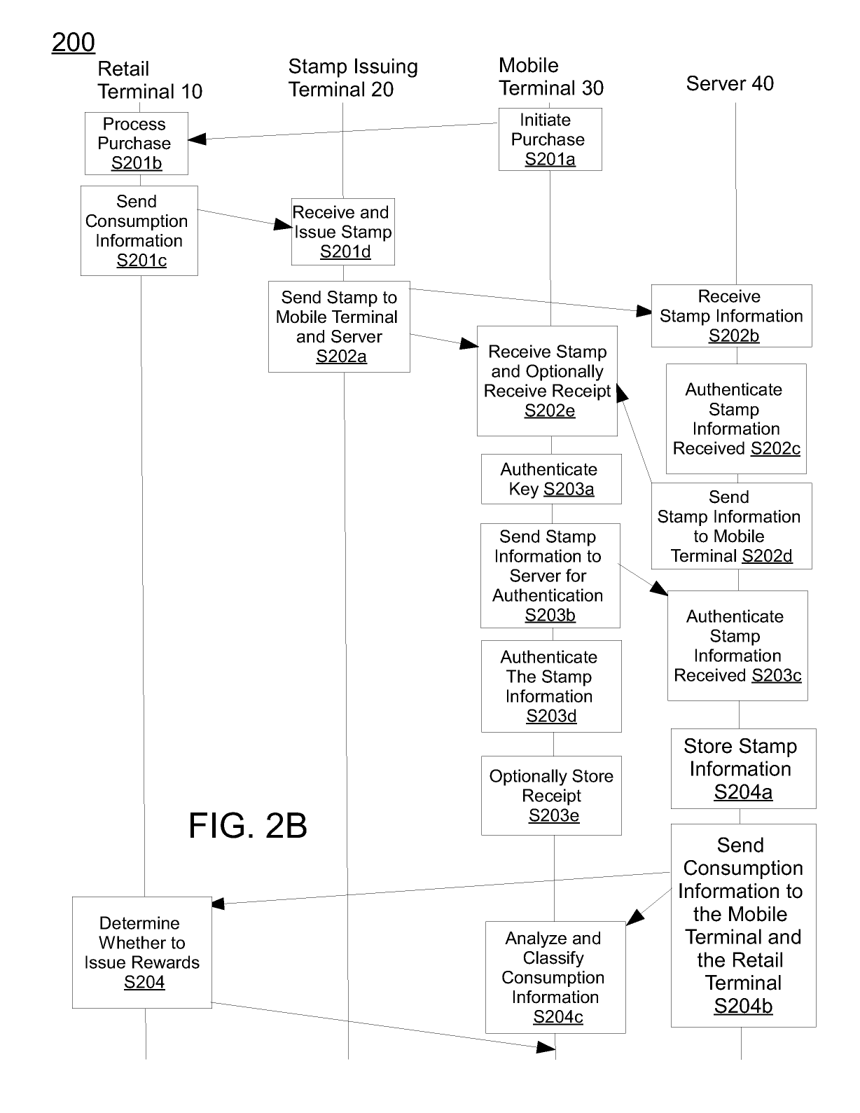

FIGS. 2A, 3A, 4A, 5A, and 6A are related to FIGS. 2B, 3B, 4B, 5B, and 6B in that FIGS. 2B, 3B, 4B, 5B, and 6B show further details of optional embodiments of the methods of FIGS. 2A, 3A, 4A, 5A, and 6A, respectively. FIGS. 2B, 3B, 4B, 5B, and 6B also clarify which terminal performs each of the steps of FIGS. 2A, 3A, 4A, 5A, and 6A, respectively. In FIGS. 2B, 3B, 4B, 5B, and 6B, the steps are placed on different lines in which each line represents the terminal that performs the indicated step. The collection of steps located on the same line are the steps performed by that terminal and represent a method implemented by that terminal.

FIGS. 2A and 2B are flowcharts of a stamp issuing method 200 implemented by the system 100 FIG. 1A.

In step S201, the stamp issuing terminal 120 generates stamp information 314 based on consumption information transmitted from the retail terminal and a predetermined stamp issuing rule.

Specifically, a customer purchases an article and pays, via the POS (Point of Sales) retail terminal 110. In optional substep S201a, the purchase may be initiated on mobile device 130. In substep S201b the purchase is processed by retail module 110. The retail terminal 110 is connected with the stamp issuing terminal 120, and in substep S201c, retail terminal 110 sends consumption information 316 (namely detailed data of a purchase receipt) of the customer to the stamp issuing terminal 120. In substep 201d, the stamp issuing terminal 120 receives the consumption information 316 sent and generates stamp information 314 based on the consumption information 316 and the predetermined stamp issuing rule 154. Then, stamp issuing terminal 120 sends the stamp information 314 to the mobile terminal 130. The consumption information 316 comprises a serial number of the purchase receipt, date and time of the purchase receipt, code of a POS processing the purchase, code of the article, a unit price of the article, an amount of the article, and total value of the purchase receipt. The predetermined stamp issuing rule may be, for example, one stamp may be obtained for every 100 dollars of consumption and 10 stamps may be obtained for every one thousand dollars of consumption. The stamp may be a two-dimensional barcode or other pattern. The present step is realized by the retail terminal 110 and the stamp issuing terminal 120.

In step S202, in substep S202a, the stamp issuing terminal sends the stamp information 314 to the mobile terminal 130, and sends the stamp information 314 and account information 312 of the mobile terminal 130 to the server 140. The mobile terminal 130 is associated with a user account in the message sent and/or at server 140.

The stamp issuing terminal 120 is designed to be adapted to the shape of the mobile terminal 130. The mobile terminal 130 is simply placed on the stamp issuing terminal 120, and then the stamp issuing terminal 120 and the mobile terminal 130 exchange signals with each other. The stamp issuing terminal 120 is linked with the server 140 to send a stamp statement to the server 140 at specific times, the stamp statement comprises a code of a specific device, next stamp signal code, stamp count, stamp signal count and the like. In an embodiment, step S202 is performed by the stamp issuing terminal 120.

In an embodiment, in step S202, the stamp issuing terminal 120 further sends the consumption information 316 to the mobile terminal 130 and the server 140, and the retail terminal 110 verifies the consumption information 316 displayed on the mobile terminal. That is, the purchase receipt is in an electronic format. The purchase receipt is downloaded to the mobile terminal 130 as a proof of purchase, which may be stored for a long time. The purchase receipt may be a ticket, so that in an embodiment of system 100, the traditional printed purchase receipt can be replaced by the mobile terminal, which acts as the purchase proof when the customer leaves a purchase location, or as a proof that the article was purchased and/or the date of purchase, when a customer wants to return, exchange, or maintain the article. At the same time, a purchased article may be a ticket. For example the purchased article may be a ticket for cinema or an amusement park. The stamp issuing terminal 120 may format the purchase receipt as an electronic ticket, including one-dimensional or two-dimensional barcode electronic ticket. When a customer enters, the ticket may be displayed, via the mobile terminal 130, and the ticket may then be read by a scanner of the retail terminal 110. In an embodiment, the stamp issuing terminal 120 may send only the serial number of the purchase receipt to the mobile terminal 130, and all of the consumption information 316 to the server 140. The mobile terminal 130 downloads all the consumption information 316 from the server 140 according to the serial number of the purchase receipt when the user needs to review the consumption information 316. Thus, the amount of information that the stamp issuing terminal 120 sends to mobile terminal 130 is reduced, and the time the customer spends to purchase article is thereby reduced.

In an embodiment, in step S202, the stamp issuing terminal 120 converts the stamp information 314 into an audio signal by an acoustic wave generating apparatus and sends the audio signal to the microphone of the mobile terminal 130. Alternatively, the stamp issuing terminal 120 converts the stamp information 314 into a magnetic signal by using an electromagnetic signal generator and sends the magnetic signal to an electromagnetic signal sensor of the mobile terminal 130. The stamp issuing terminal 120 converts the stamp information 314 into a radio wave signal by using a near field communication transceiver and sends the radio wave signal to the smart card chip of the mobile terminal 130.

Ancillary to step S202, in substep S202b, the server 140 receives the stamp information 314. In substep S202c, server 140 authenticates the stamp information 314. In substep S202d, server 140 sends the stamp information 314 to mobile terminal 130. In substep S202e, mobile terminal 130 receives some stamp information 314 from retail terminal 110 (e.g., the serial number or identifier of the stamp) and other stamp information 314 from server 140. Optionally, the receipt information is stored at mobile terminal 130 (which will be discussed in substep S203e, below), and the consumption information 316 is analyzed and classified at mobile terminal 130 (which will be discussed in substep S204c, below). The analysis and classification may be sent to server 140.

In step S203, the mobile terminal 130 authenticates the stamp information 314, and stores the stamp into the user account associated with the mobile terminal after the authentication is successful. Specifically, the mobile terminal 130 communicates with the stamp issuing terminal 120, receives the stamp information 314 transmitted by the stamp issuing terminal 120, and authenticates and decrypts the stamp information 314. The mobile terminal 130 generally performs the authentication and decryption in the following three manners: (1) in substep S203a, mobile terminal 130 performs the authentication and decryption with a predetermined PKI (Public Key Infrastructure), (2) in substep S203b, mobile terminal 130 sends the stamp information 314 to the server 140, and in substep S203c, server 140 the decrypts and authenticates the stamp information 314, (3) in substep S203d, the mobile terminal 130 performs the authentication and decryption by itself. As background, server 140 is assumed to be trustworthy. The stamp issuing terminal is somewhat trustworthy. However, as a precaution, the mobile terminal 130 is assumed not to be trustworthy. A hacker can produce a program running on the mobile terminal 130 to falsely claim that the hacker had received a certain number stamps. The substep S203a allows the mobile terminal to confirm that the stamp is OK. The stamp is genuinely O.K. when the mobile terminal 130 is running the genuine program. Substep S203d facilitates detecting of communication errors or program bugs. For substep S203b, S203c the server is really doing the authentication and reply the same to the mobile terminal Note that both mobile device 131 and server 140 each perform an authentication. At the same time, the mobile terminal 130 may further display reward information, such as a reward coupon, a stamp, a lottery draw opportunity and the like. In substep 203e, the receipt information is stored at mobile terminal 130. Step S203 is realized by the mobile terminal 130.

In step S204 (substep S204a), the server 140 stores and updates the stamp information 314 in the user account corresponding to the mobile terminal. Specifically, the server 140 receives the stamp information 314 and the corresponding user account transmitted by the stamp issuing terminal 120, stores the stamp information 314 and updates the information, such as the stamp number and the stamp type, for example, in the user account. In an embodiment, a system administrator may establish stamp issuing terminal database (e.g. table of terminals 151, FIG. 1D), a stamp type database, a reward coupon type database (e.g., reward type 142, FIG. 1D), an issuing stamp rule database (e.g., stamp issuing rules 154, FIG. 1D), and stamp redeem reward coupon rule database (e.g., reward issuing rules 160, FIG. 1D), via a data interface. Wherein, the stamp issuing terminal database stores coordinate data of longitude, latitude and altitude where the stamp issuing terminal 120 is mounted. The stamp issuing terminal database that stores the geographical position coordinates of the stamp issuing terminal 120 at the server 140. Step S204 is realized by the server 140.

Furthermore, in substep S204b, the server 140 regularly sends the consumption information 316 at predetermined times to the retail terminal 110 and the mobile terminal 130. The retail terminal 110 provides a reward based on the consumption information 316 sent (at the predetermined time) from the mobile terminal 130 and the predetermined reward rules. The reward information and the user account information 312 corresponding to the reward information sent to the server 140. In substep S204c, the mobile terminal 130 performs statistics on the consumption information 316 within the predetermined time and classifies the consumption information 316.

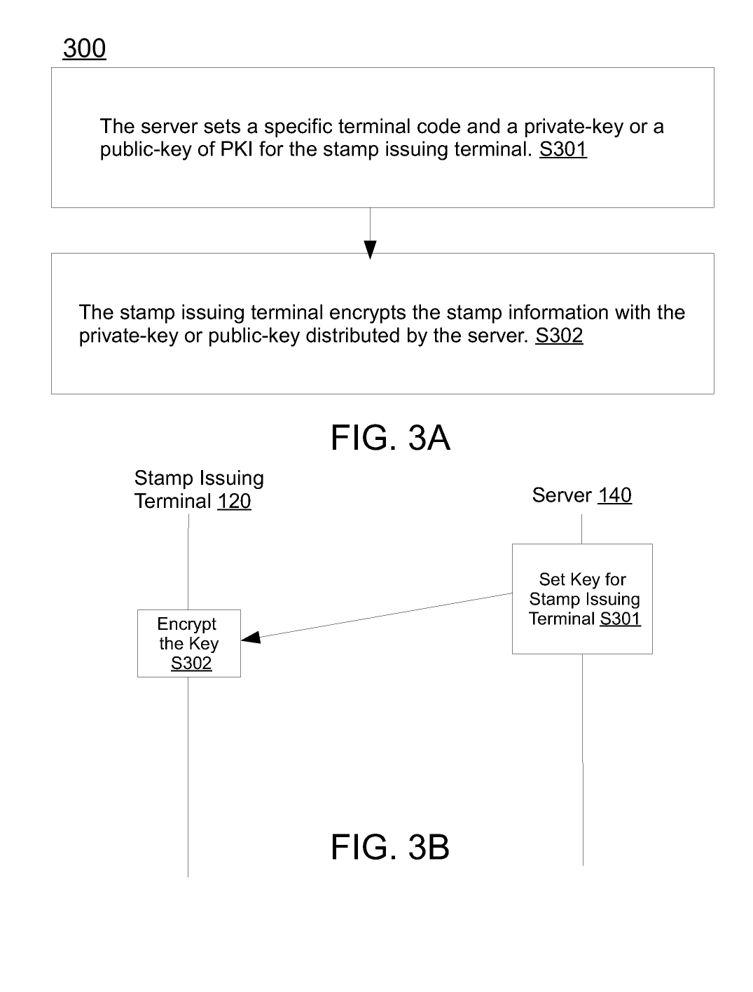

FIGS. 3A and 3B are flowcharts of an example of a method 300 in which the stamp information 314 is encrypted according to a first embodiment by the server 140 and the stamp issuing terminal 120 as shown in FIG. 1A.

In step S301, the server 140 sets a specific terminal code and a private-key or a public-key of PKI for the stamp issuing terminal Step S301 is realized by the setting module 141 of the server 140.

In step S302, the stamp issuing terminal 120 encrypts the stamp information 314 with the private-key or public-key distributed by the server. Step S302 is realized by the encryption module 121 of the stamp issuing terminal 120.

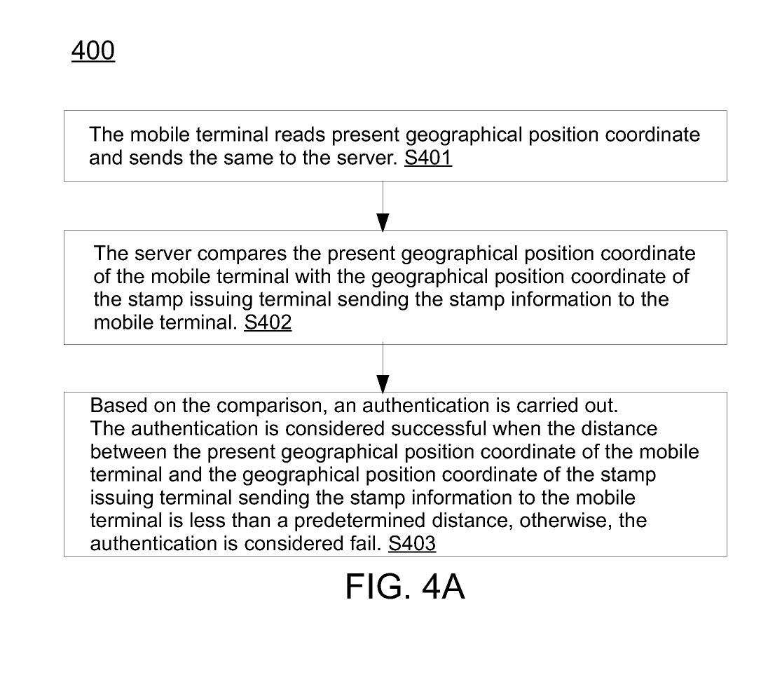

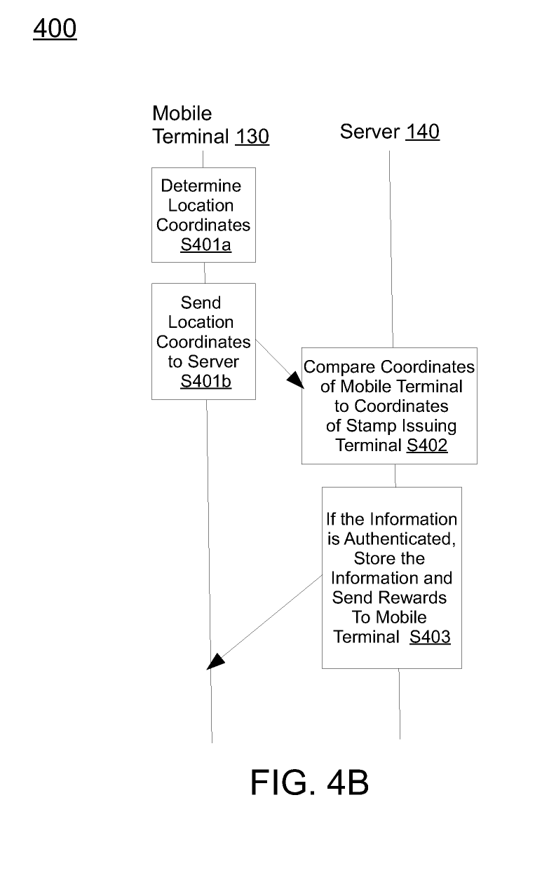

FIGS. 4A and 4B are flowcharts of method 400 in which the stamp information 314 is authenticated by a mobile terminal (in step S202 or S203 of FIG. 2A) according to the second embodiment and which is realized by the mobile terminal 130 and the server 140 as shown in FIG. 1A.

In step S401, in substep S401a, the mobile terminal 130 reads or otherwise determines the present geographical position coordinates, and, in substep S401b, mobile terminal 130 sends the present geographical position coordinates to the server.

In step S402, the server 140 compares the present geographical position coordinates of the mobile terminal 130 with the geographical position coordinates of the stamp issuing terminal 120, which sent the stamp information 314 to the mobile terminal 130.

In step S403, if the authentication is considered successful, the stamp information 314 is sent to the mobile terminal 130 (e.g., in step S202) and/or stored at the server 140 (e.g., in step S203 or S204). If the distance between the present geographical position of the mobile terminal and the geographical position of the stamp issuing terminal 120 is less than a predetermined distance, the authentication is considered successful. Otherwise, the authentication is considered to have failed.

The stamp issuing method of at least one embodiment provides at least one optional reward to the mobile terminal 130 (e.g., via retail terminal 110) and updates the stamp information 314 according to the reward selected by the mobile terminal 130 by using the server 140.

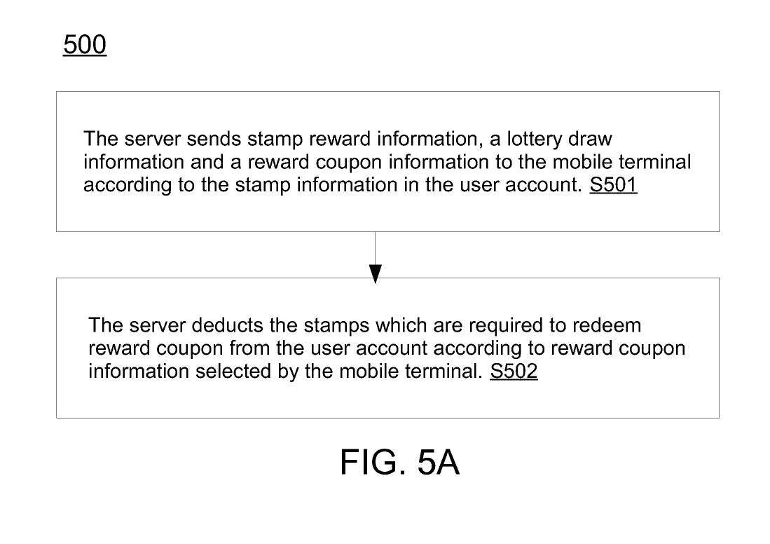

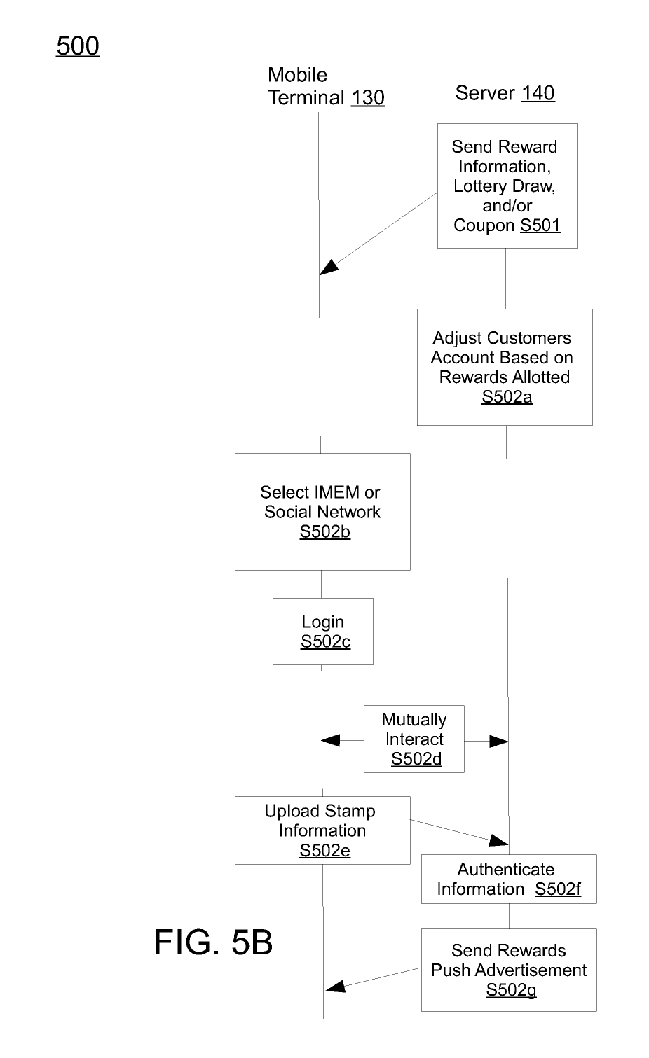

FIGS. 5A and 5B are flowcharts of a method 500 in which the server 140 provides a reward to the mobile terminal 130 according to the third embodiment and which is realized by the mobile terminal 130 and the server 140 as shown in FIG. 1A.

Stamps generally are issued at time of purchase (but may be issued at other times also). In an embodiment, the stamping issuing process requires a POS terminal (a retail terminal 110) to issue commands to the stamp issuing terminal 120. During the process of issuing command to the stamp issuing terminal 120, the mobile terminal 130 receives information from the stamp issuing terminal 120 (which originates from the retail terminal 110), so that the POS terminal can send rewards via the stamping issuing device to mobile terminal 130. However, in other cases, where there is no purchase (for example perhaps the customer is checking the program in the mobile terminal 130, or during the server initial the action) and the number of stamps of an account is reviewed and at this time, the mobile terminal 130 is not communicating with the stamp issuing terminal 120. Since there is no communication with the stamp issuing terminal 120, the communication is directly between the server 140 and the mobile terminal 130. Consequently, the rewards are sent by the server 140.

In step S501, the server 140 sends stamp reward information, a lottery draw information, and/or a reward coupon information to the mobile terminal based on the stamp information 314 in the user account. Step S501 is realized by the reward module 142 of the server 140.

In step S502 (substep S502a), the server 140 deducts the stamps that are required to redeem reward coupon from the user account based on reward coupon information selected by the mobile terminal Step S502 is realized by the server 140.

In an embodiment, in optional substep S502b, the stamp issuing method also includes: the mobile terminal 130 selects International Mobile Equipment Identity (IMEM) of the mobile terminal 130 or a social network account registered by the mobile terminal 130 as a user account to login to the server 140. In substep S502c, mobile terminal 130 logs into server 140. After the mobile terminal 130 logs in, in substep S502d the mobile terminal 130 and the server 140 interact with one another mutually. In substep S502e, the mobile terminal 130 may upload the stamp information 314, which in substep S502f, is decrypted and authenticated, to obtain a reward, or to perform a lottery draw, for example. In substep S502g, the server 140 may push an advertisement to the mobile terminal 130, receive and answer inquiries about stamp information 314, receive request for and provide reward information, and receive request for and provide lottery information, for example.

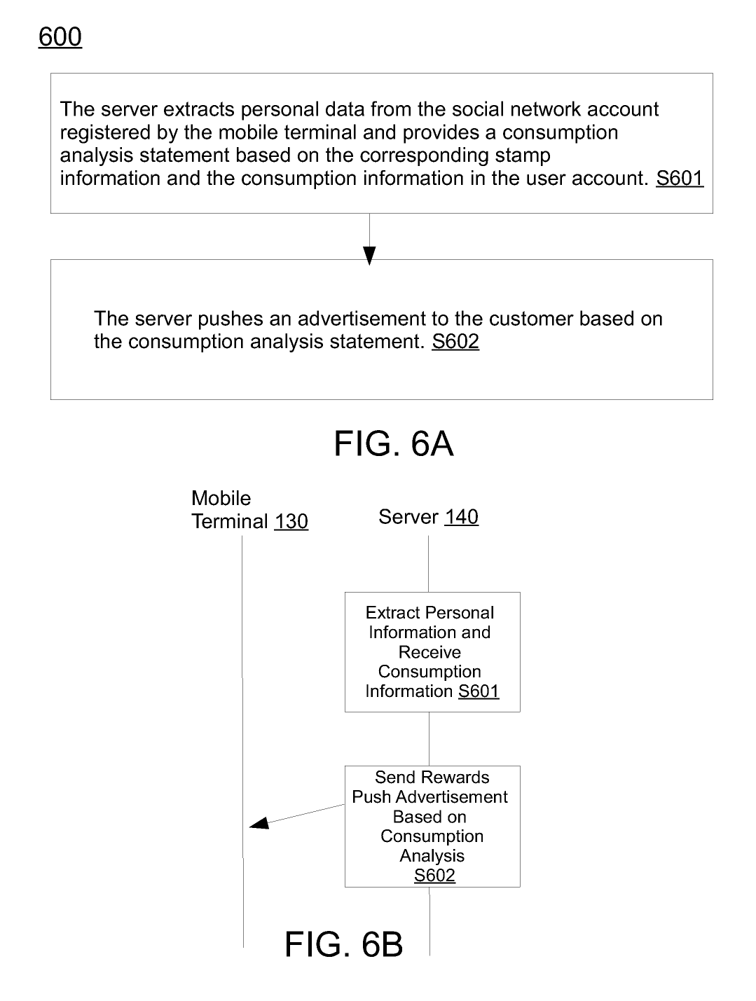

FIGS. 6A and 6B are flowcharts of a method 600 in which advertisement is pushed according to the fourth embodiment and which is realized by the server 140 as shown in FIG. 1A.

Step S601, the server 140 extracts personal data from the social network account registered by the mobile terminal, and the server 140 analyzes the consumption data 316 producing an analysis statement (based on the corresponding stamp information 314 and the consumption information 316 in the user account).

Step S602, the server pushes an advertisement to the customer based on the consumption analysis and/or consumption analysis statement.

When the customer chooses to login via the social network account, the server 140 extracts personal data from the social network, and provide an analysis statement according to the stamp data and data of the purchase receipt. Server 140 analyzes a consumption mode and consumption preferences, for example. The server 140 regularly provides (at predetermined times) relevant promotional information to the customer, including favorable rewards, for example, with respect to the consumption mode and the preferences of the customer. Thereby, at least some embodiments of system 100 can analyze and obtain consumption preferences of the customer. The consumption preferences are based on the customer data. As a result of taking into account consumption preferences, system 100 provides the customer with an advertisement that is effective, attractive, and conforms to the customer preferences based on the patterns of consumption of the customer, so to provide advertisement articles that are more effective than were the choice of advertisement articles at random.

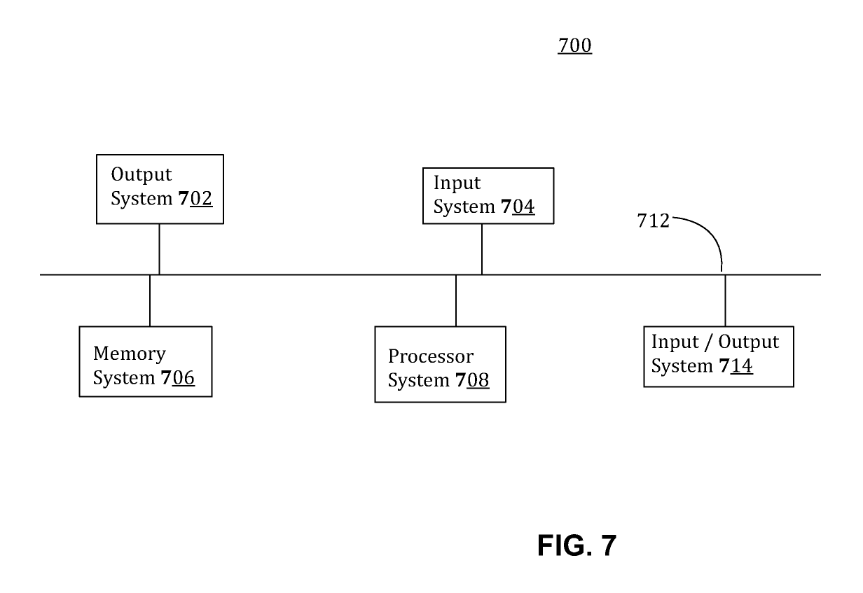

FIG. 7 shows a block diagram of a computer 700 used in system 100. The computer 700 may include output system 702, input system 704, memory system 706, processor system 708, communications system 712, and input/output device 714. In other embodiments, computer 700 may include additional components and/or may not include all of the components listed above.

Computer 700 is an example of a computer that may be used for retail terminal 110 and/or server 140.

Output system 702 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. In an embodiment of computer 700 that is used as retail terminal 110, output system 702 may include a display for displaying the prices of items purchased. Output system 714 may also include an interface for communicating with stamp issuing terminal 120.

Input system 704 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. In an embodiment of computer 700 that is used as retail terminal 110, input system 704 may include special keys for inputting the prices and codes of items being purchased.

Memory system 706 may include, for example, any one of, some of, any combination of, or all of a long term storage system, such as a hard drive; a short term storage system, such as random access memory; a removable storage system, such as a floppy drive or a removable drive; and/or flash memory. Memory system 706 may include one or more machine-readable mediums that may store a variety of different types of information. The term machine-readable medium is used to refer to any non-transient medium capable carrying information that is readable by a machine. One example of a machine-readable medium is a non-transient computer-readable medium. Another example of a machine-readable medium is paper having holes that are detected that trigger different mechanical, electrical, and/or logic responses. In an embodiment of computer 700 that is used as retail terminal 110, memory system 706 may include software for communicating with stamp issuing terminal 120, which may include machine instructions for transmitting consumption information 316 to stamp issuing terminal 120 and optionally for transmitting rewards to mobile terminal 130. In an embodiment of computer 700 that is used as retail terminal 110, memory system 706 may include software for processing purchases, tracking inventory, issuing awards, and/or sending consumption data to stamp issuing data 120. In an embodiment of computer 700 that is used as server 140, memory system 706 may include setting module 141, reward module 142, personal data extraction module 143, analysis module 144, advertisement pushing module 145, comparison module 146, software for implementing steps S204 (FIG. 2A), S301 (FIG. 3A), S402, S403 (FIG. 4A), method 500 (FIG. 5A), and method 600 (FIG. 6A).

Processor system 708 may include any one of, some of, any combination of, or all of multiple parallel processors, a single processor, a system of processors having one or more central processors and/or one or more specialized processors dedicated to specific tasks. In an embodiment of computer 700 that is used as retail terminal 110, processor system 708 may implement machine instructions stored in memory system 706, such as software for processing purchases, tracking inventory, issuing awards, and/or sending consumption data to stamp issuing data 20. In an embodiment of computer 700 that is used as server 140, processor 708 may implement the machine instructions stored in memory 706, such as setting module 141, reward module 142, personal data extraction module 143, analysis module 144, advertisement pushing module 145, comparison module 146, software for implementing steps S204 (FIG. 2A), S301 (FIG. 3A), S402, S403 (FIG. 4A), method 500 (FIG. 5A), and method 600 (FIG. 6A), if computer 700 is used as server 140.

Communications system 712 communicatively links output system 702, input system 704, memory system 706, processor system 708, and/or input/output system 714 to each other. Communications system 712 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 714 may include devices that have the dual function as input and output devices. For example, input/output system 714 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 714 is optional, and may be used in addition to or in place of output system 702 and/or input device 704.

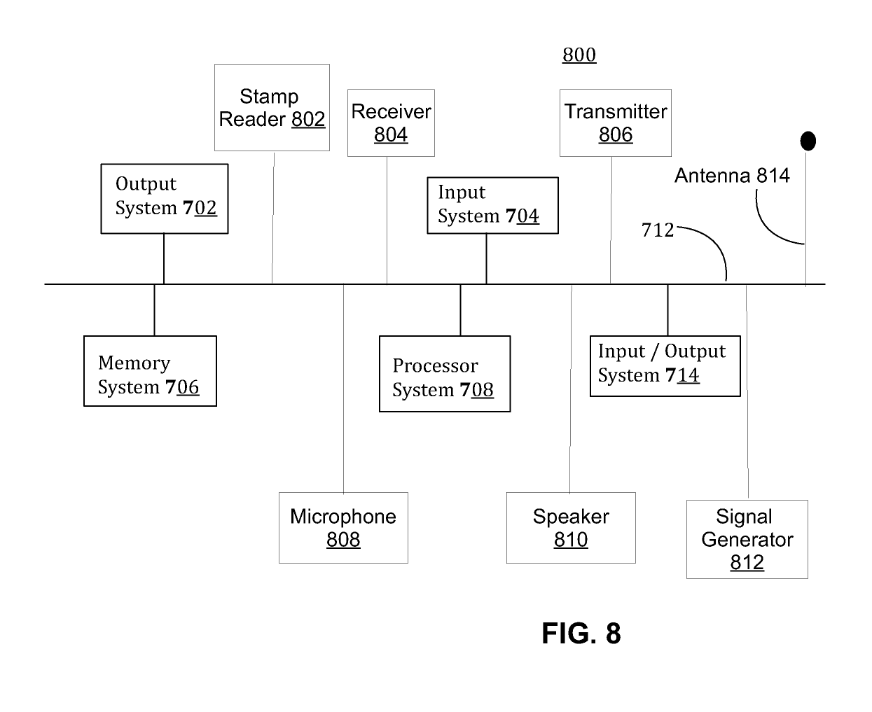

FIG. 8 shows a block diagram of an embodiment of stamp issuing terminal 120 used in system 100. Stamp issuing terminal 120 may include output system 702, input system 704, memory system 706, processor system 708, communications system 712, input/output device 714, stamp reader 802, receiver 804, transmitter 806, microphone 808, speaker 810, signal generator 812, and antenna 814. In other embodiments, stamp issuing terminal 120 may include additional components and/or may not include all of the components listed above.

Output system 702, input system 704, memory system 706, processor system 708, communications system 712, and input/output device 714 are described in conjunction with FIG. 7. However, output system 702 includes display 122, input system 704 includes input module 123, and memory system 706 stores encryption instructions 121. Memory system 702 of stamp issuing terminal 120 also includes machine instructions for steps S201, S202 (FIG. 2A), and S302 (FIG. 3A). Processor system 708 implements the machine instructions of encryption instructions 121 and steps S201, S202 (FIG. 2A), and S302 (FIG. 3A).

Stamp reader 802 may be a scanner for scanning the stamp displayed on the display of mobile terminal 130. Stamp reader 802 may include a barcode reader and/or an optical scanner. Receiver 804 processes the signals received from retail terminal 110, mobile terminal 130, and/or server 140. Transmitter 806 prepares signals for transmission to retail terminal 110, mobile terminal 130, and/or server 140. Microphone 808 receives audio signals from mobile terminal 130. Speaker 810 produces audio signals, which may be sent to mobile terminal 130. In an embodiment, speaker 810 produces a near field signal. Signal generator 812 produces signals, which may be converted into electromagnetic signals and/or audio signals. Antenna 814 may send and receive electromagnetic signal. Antenna 814 is an electromagnetic sensor.

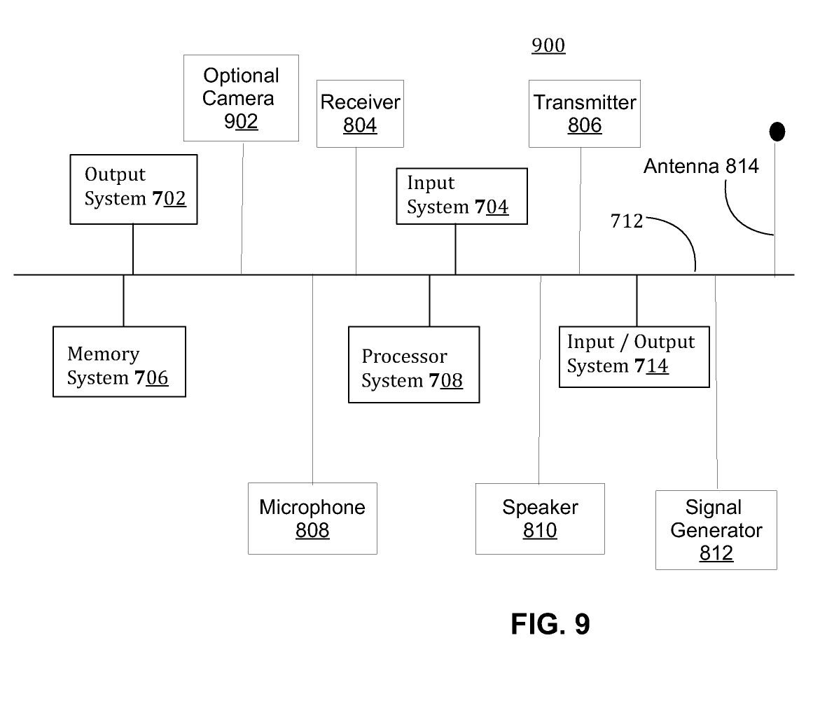

FIG. 9 shows a block diagram of mobile terminal 130 used in system 100. Stamp issuing terminal 120 may include output system 702, input system 704, memory system 706, processor system 708, communications system 712, input/output device 714, receiver 804, transmitter 806, microphone 808, speaker 810, signal generator 812, antenna 814, and optional camera 902. In other embodiments, mobile terminal 130 may include additional components and/or may not include all of the components listed above.

Output system 702, input system 704, memory system 706, processor system 708, communications system 712, and input/output device 714 are described in conjunction with FIG. 7, and stamp reader 802, receiver 804, transmitter 806, microphone 808, speaker 810, signal generator 812, and antenna 814 are described in conjunction with FIG. 8. However, microphone 808 may be the mini-microphone mentioned above.

However, memory system 706 of mobile terminal 130 stores account login module 131 and positioning module 132. Processor system 708 implements the machine instructions of account login module 131 and positioning module 132. Memory system 7086 may include a smart card chip capable of storing the stamp application 232, such as a SIM card or a Secure Memory Card.

Stamp reader 802 may be a scanner for scanning the stamp displayed on the display of mobile terminal 130. Stamp reader 802 may include a barcode reader and/or an optical scanner. Receiver 804 processes the signals received from retail terminal 110, stamp issuing terminal 120, and/or server 140. Transmitter 806 prepares signals for transmission to retail terminal 110, stamp issuing terminal 120, and/or server 140. Microphone 808 receives audio signals from stamp issuing terminal 120 (in addition to being used for carrying on a conversation during a phone call). Speaker 810 produces audio signals, which may be sent to stamp issuing terminal 120 (in addition to being used for carrying on a conversation during a phone call). Optional camera 902 is a camera that may come with the mobile terminal 130.

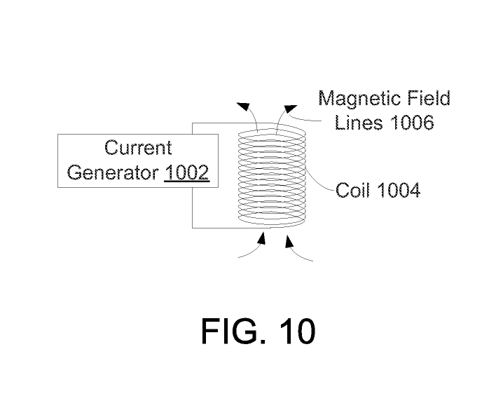

FIG. 10 shows a block diagram of an embodiment of signal generator 124 of stamp issuing terminal 120. Signal generator 124 may include current generator 1002, coil 1004, and a magnetic field having magnetic field lines 1006. In other embodiments, signal generator 124 may include additional components and/or may not include all of the components listed above.

Signal generator 124 was discussed in conjunction with FIG. 1B. The embodiment relevant to FIG. 10 is discussed conjunction with Table 1 and FIG. 1A. Signal generator 124 produces a changing magnetic field. Current generator 1002 produces a current, whose direction may be changed. Coil 1004 produces a magnetic field as current flows through coils 1004 (optionally coils 1004 may be wrapped around a ferromagnetic material to enhance the field). Magnetic field lines 1006 indicate the direction of the magnetic field. As the direction of the current is changed, the direction of magnetic field lines 1006 change. In other embodiments, other methods may be used for producing an electromagnetic signal for the mobile terminal 130 to read instead of that of FIG. 10.

In a conclusion, in system 100, the stamp issuing terminal 120 sends the stamp information 314 to the mobile terminal 130, and sends the stamp information 314 and the account information 312 of the mobile terminal 130 to the server 140. The mobile terminal 130 stores the stamp into the user account associated with the mobile terminal 130. The server 140 stores and updates the stamp information 314 in the user account corresponding to the mobile terminal 130. The mobile terminal 130 is used as a carrier for the stamp, without storing the stamp or the membership card as a physical entity. Also, the user can inquire about the stamps in the user account by using the mobile terminal 130, providing a better consumption experience to the customer. By establishing a low cost customer reward platform that can be shared by a plurality of stores and by storing various types of stamps in the same mobile terminal, the competitiveness of medium and small stores can be greatly increased. As a result, in system 100, a stamp can be sent to the mobile terminal 130 from the stamp issuing terminal 120. As a result of the use of the mobile terminal 130 as a carrier for the stamp, the stamp inquiry becomes convenient, the user experience is enhanced, and the cost is reduced. Further, in system 100, consumption patterns of the customer can be analyzed and obtained based on the customer data. The customer is provided with an advertisement article that is effective, attractive, and conforms to customer preferences based on the consumption patterns.

### ALTERNATIVES AND EXTENSIONS

Each embodiment disclosed herein may be used or otherwise combined with any of the other embodiments disclosed. Any element of any embodiment may be used in any embodiment.

System 100 may have other various embodiments, without departure from spirit and essence of the present specification, a person skilled in the art may make various corresponding modifications and variations according to the present specification. However, these modifications and variations should fall within the protective scope of the appended claims of the present specification.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

What is claimed:

1. A stamp issuing method, comprising:
receiving, at a stamp issuing terminal from a retail terminal, consumption information associated with a customer, the stamp issuing terminal having at least a processor system including at least one processor and a network interface for communicating with a mobile terminal and a server;
generating, by the stamp issuing terminal, stamp information based on the consumption information transmitted from the retail terminal and a predetermined stamp issuing rule;
sending, from a stamp issuing terminal, the stamp information to a mobile terminal, and
sending, from the stamp issuing terminal, the stamp information and account information of the mobile terminal to a server, the mobile terminal being associated with a user account.

2. The stamp issuing method according to claim 1, further comprising:
sending the consumption information from the stamp issuing terminal to the mobile terminal and to the server.

3. The stamp issuing method according to claim 1, wherein the stamp information comprises
a terminal code of the stamp issuing terminal,
a serial number of the stamp information,
a time of the stamp information,
an article classification code,
a stamp code, and
a stamp amount.

4. The stamp issuing method according to claim 1, wherein the consumption information comprises:
a serial number of the purchase receipt,
a date and time of the purchase receipt,
a code of a point of sale (POS) where the purchase was processed,
a code of the article,
a unit price of the article,
an amount of the article, and
a total value of the purchase receipt.

5. The stamp issuing method according to claim 1, wherein the consumption information comprises:
ticket information.

6. The stamp issuing method according to claim 5, wherein the step of sending from the stamp issuing terminal the consumption information to the mobile terminal and the server comprises:
sending, from the stamp issuing terminal, only the serial number of the purchase receipt to the mobile terminal, and
sending, from the stamp issuing terminal, the consumption information to the server.

7. The method of claim 1,
receiving, at the stamp issuing terminal from the server, an encryption key;
encrypting, by the stamp issuing terminal, the stamp information using the encryption key received from the server.

8. The stamp issuing method according to claim 1, wherein the step of sending, by the stamp issuing terminal, the stamp information to the mobile terminal from comprises:
converting, by stamp issuing terminal, the stamp information into an audio signal using an acoustic wave generating apparatus and sending an audio signal to a microphone of the mobile terminal from the stamp issuing terminal;
converting, by the stamp issuing terminal, the stamp information into a magnetic signal using an electromagnetic signal generator;
sending, by the stamp issuing terminal, the stamp information to an electromagnetic signal sensor of the mobile terminal from the stamp issuing terminal, or converting the stamp information into a radio wave signal using a near field communication transceiver; and
sending, by the stamp issuing terminal, the stamp information to the mobile terminal.

9. A method comprising:
receiving at a server, from a stamp issuing terminal, stamp information and account information of the mobile terminal to the server, the mobile terminal being associated with a user account, the server having at least a processor system including at least one processor, a memory system, and a network interface;
authenticating, by the server, the stamp information received, and
if the authentication is successful, storing, by the server, the stamp in association with the user account that is associated with the mobile terminal; and
storing and updating, by the server, the stamp information in the user account corresponding to the mobile terminal.

10. The stamp issuing method according to claim 9, further comprising:
periodically sending from the server to the retail terminal and the mobile terminal, the consumption information.

11. The stamp issuing method according to claim 9, further comprising:
setting, by the server, a specific terminal code and an encryption key for the stamp issuing terminal.

12. The stamp issuing method according to claim 9, further comprising:
recording, by the server, geographical position coordinates of the stamp issuing terminal.

13. The method of claim 9, further comprising:
comparing, by the server, present geographical position coordinates of the mobile terminal and geographical position coordinates of the stamp issuing terminal sending the stamp information to the mobile terminal; the authentication is considered successful when a distance between the present geographical position coordinates of the mobile terminal and the geographical position coordinates of the stamp issuing terminal to the mobile terminal is less than a predetermined distance, otherwise, the authentication is considered fail.

14. The stamp issuing method according to claim 9, wherein the geographical position coordinates comprises longitude, latitude, and altitude.

15. The stamp issuing method according to claim 9, further comprising:
providing, by the server, at least one reward to the mobile terminal.

16. The stamp issuing method according to claim 9, wherein the providing, by the server, the at least one reward to the mobile terminal further comprising:
sending stamp reward information, lottery draw information, and
sending reward coupon information to the mobile terminal based on the stamp information in the user account.

17. The stamp issuing method according to claim 9, further comprising:
extracting personal data, by the server from a social network account registered by the mobile terminal;
providing, by the server, a consumption analysis based on corresponding stamp information and the consumption information in the user account;
pushing, by the server, an advertisement to the customer according to the consumption analysis statement; and
establishing, by the server, a stamp issuing terminal database, stamp type database, reward coupon type database, issuing stamp rule database, and stamp redeem reward coupon rule database.

18. A method comprising:
receiving, at a mobile terminal from a stamp issuing terminal, an identifier of stamp information, the mobile terminal having a processor system including at least one processor, a memory system and a display;
receiving, at the mobile terminal from a server, information about the stamp, the information about the stamp being information that was not provided by the stamp issuing terminal;
storing, by the mobile terminal, the identifier of the stamp and information about the stamp received from the server in association with the identifier of the stamp in the memory system as the stamp in digital format; and
displaying the stamp on the display of the mobile device.

19. The method of claim 18 further comprising:
while displaying the stamp,
placing the display near a retail terminal, and
receiving, a near field signal, from a stamp issuing terminal, therein completing a transaction associated with the stamp;
displaying on the display an indication that the transaction associated with the stamp is complete.

20. The method of claim 18, further comprising:
providing, on the mobile terminal, a reward based on consumption information within a predetermined time and a predetermined reward rule, and
performing, by the mobile terminal, statistics on the consumption information within the predetermined time, and classifying the consumption information.

21. A stamp issuing system, comprising:
a processor system having at least one processor;
a network interface; and
a memory system storing one or more machine instructions on one or more non-transitory computer readable media; when the machine instructions are implemented, the machine instructions cause a processor to implement a method including at least
receiving, at the stamp issuing terminal from a retail terminal, consumption information associated with a customer;
generating, by the stamp issuing terminal, stamp information based on the consumption information transmitted from the retail terminal and a predetermined stamp issuing rule;
sending, from a stamp issuing terminal, the stamp information to a mobile terminal, and
sending, from the stamp issuing terminal, the stamp information and account information of the mobile terminal to a server, the mobile terminal being associated with a user account.

22. The stamp issuing terminal of claim 21, the method implemented by the one or more machine instructions, further comprising:
sending the consumption information from the stamp issuing terminal to the mobile terminal and to the server.

23. The stamp issuing terminal of claim 21, wherein the stamp information comprises
a terminal code of the stamp issuing terminal,
a serial number of the stamp information,
a time of the stamp information,
an article classification code,
a stamp code, and
a stamp amount.

24. The stamp issuing terminal of claim 21, wherein the consumption information comprises:
a serial number of the purchase receipt,
a date and time of the purchase receipt,
a code of a point of sale (POS) where the purchase was processed,
a code of the article,
a unit price of the article,
an amount of the article, and
a total value of the purchase receipt.

25. The stamp issuing terminal of claim 21, wherein the consumption information further comprises:
ticket information.

26. The stamp issuing terminal according to claim 25, wherein the step of sending from the stamp issuing terminal the consumption information to the mobile terminal and the server comprises:
sending, from the stamp issuing terminal, only the serial number of the purchase receipt to the mobile terminal, and
sending, from the stamp issuing terminal, the consumption information to the server.

27. The stamp issuing terminal of claim 21, the method implemented by the one or more machine instructions, further comprising:
receiving, at the stamp issuing terminal from the server, an encryption key;
encrypting, by the stamp issuing terminal, the stamp information using the encryption key received from the server.

28. The stamp issuing terminal according to claim 1, wherein the step of sending, by the stamp issuing terminal, the stamp information to the mobile terminal from comprises:
converting, by stamp issuing terminal, the stamp information into an audio signal using an acoustic wave generating apparatus and sending an audio signal to a microphone of the mobile terminal from the stamp issuing terminal;
converting, by the stamp issuing terminal, the stamp information into a magnetic signal using an electromagnetic signal generator;
sending, by the stamp issuing terminal, the stamp information to an electromagnetic signal sensor of the mobile terminal from the stamp issuing terminal, or converting the stamp information into a radio wave signal using a near field communication transceiver; and
sending, by the stamp issuing terminal, the stamp information to the mobile terminal.

29. A server, comprising:
a processor system having at least one processor;
a network interface; and
a memory system storing one or more machine instructions on one or more non-transitory computer readable media; when the machine instructions are implemented, the machine instructions cause a processor to implement a method including at least
receiving at a server, from a stamp issuing terminal, stamp information and account information of the mobile terminal to the server, the mobile terminal being associated with a user account, the server having at least a processor system including at least one processor, a memory system, and a network interface;
authenticating, by the server, the stamp information received, and
if the authentication is successful, storing, by the server, the stamp in association with the user account that is associated with the mobile terminal; and
storing and updating, by the server, the stamp information in the user account corresponding to the mobile terminal.

30. The server of claim 29, the method, implemented by the one or more machine instructions, further comprising:
periodically sending from the server to the retail terminal and the mobile terminal, the consumption information.

31. The server of claim 29, the method, implemented by the one or more machine instructions, further comprising:
setting, by the server, a specific terminal code and an encryption key for the stamp issuing terminal.

32. The server of claim 29, the method, implemented by the one or more machine instructions, further comprising:
recording, by the server, geographical position coordinates of the stamp issuing terminal.

33. The server of claim 29, the method, implemented by the one or more machine instructions, further comprising:
comparing, by the server, a present geographical position coordinates of the mobile terminal and geographical position coordinates of the stamp issuing terminal sending the stamp information to the mobile terminal; the authentication is considered successful when a distance between the present geographical position coordinates of the mobile terminal and the geographical position coordinates of the stamp issuing terminal to the mobile terminal is less than a predetermined distance, otherwise, the authentication is considered fail.

34. The server of claim 29, wherein the geographical position coordinates comprises longitude, latitude, and altitude.

35. The server of claim 29, the method, implemented by the one or more machine instructions, further comprising:
providing, by the server, at least one reward to the mobile terminal.

36. The server of claim 29, wherein the providing, by the server, the at least one reward to the mobile terminal further comprising:
sending stamp reward information, lottery draw information, and
sending reward coupon information to the mobile terminal based on the stamp information in the user account.

37. The server of claim 29, the method, implemented by the one or more machine instructions, further comprising:
extracting personal data, by the server from a social network account registered by the mobile terminal;
providing, by the server, a consumption analysis based on corresponding stamp information and the consumption information in the user account;
pushing, by the server, an advertisement to the customer according to the consumption analysis statement; and
establishing, by the server, a stamp issuing terminal database, stamp type database, reward coupon type database, issuing stamp rule database, and stamp redeem reward coupon rule database.

38. A mobile terminal, comprising:
a processor system having at least one processor;
a network interface; and
a memory system storing one or more machine instructions on one or more non-transitory computer readable media; when the machine instructions are implemented, the machine instructions cause a processor to implement a method including at least
receiving, at a mobile terminal from a stamp issuing terminal, an identifier of stamp information, the mobile terminal having a processor system including at least one processor, a memory system and a display;
receiving, at the mobile terminal from a server, information about the stamp, the information about the stamp being information that was not provided by the stamp issuing terminal;
storing, by the mobile terminal, the identifier of the stamp and information about the stamp received from the server in association with the identifier of the stamp in the memory system as the stamp in digital format; and
displaying the stamp on the display of the mobile device.

39. The mobile terminal of claim 38, the method, implemented by the one or more machine instructions, further comprising:
while displaying the stamp,
placing the display near a retail terminal, and
receiving, a near field signal, from a stamp issuing terminal, therein completing a transaction associated with the stamp;
displaying on the display an indication that the transaction associated with the stamp is complete.

41. The mobile terminal of claim 38, the method, implemented by the one or more machine instructions, further comprising:
providing, on the mobile terminal, a reward based on consumption information within a predetermined time and a predetermined reward rule, and
performing, by the mobile terminal, statistics on the consumption information within the predetermined time, and classifying the consumption information.
